(19) United States
(12) Patent Application Publication
(10) Pub. No.: US 2023/0345563 A1
(43) Pub. Date: Oct. 26, 2023

(54) WIRELESS ADAPTER AND/OR ADAPTER SYSTEM CONFIGURED TO PROVIDE ENHANCED WIRELESS PERFORMANCE

(71) Applicant: PPC BROADBAND, INC., East Syracuse, NY (US)

(72) Inventor: Paul Bailey, Camillus, NY (US)

(73) Assignee: PPC BROADBAND, INC., East Syracuse, NY (US)

(21) Appl. No.: 18/138,922

(22) Filed: Apr. 25, 2023

Related U.S. Application Data
(60) Provisional application No. 63/334,701, filed on Apr. 26, 2022.

(51) Int. Cl. H04W 76/15; H04W 76/19

(52) U.S. Cl. CPC H04W 76/15; H04W 76/19; H04W 88/04

(57) ABSTRACT

A wireless adapter and/or adapter system that may be configured to provide enhanced wireless performance, such as an extended wireless range. The adapter and/or adapter system may include a receiver that may be configured to receive wireless signals over a first wired connection, and that may be configured to receive the wireless signals and to direct the wireless signals to a first wireless device. The receiver also may be configured to direct the wireless signals over a second wired connection to a second wireless adapter so as to configure the second wireless adapter to wirelessly transmit the wireless signals to a second wireless device so as to extend the wireless range. The second wireless device is outside of a wireless range of the first wireless adapter and the second wireless device is within a wireless range of the second wireless adapter.

### CROSS-REFERENCE TO RELATED APPLICATION

This application claims priority to U.S. Provisional Patent Application No. 63/334,701, filed on Apr. 26, 2022, the disclosure of which is incorporated herein by reference in its entirety.

### BACKGROUND

Many residences today utilize wireless transmission, such as WiFi, to provide network signals to various devices in a residence or other location. Typical WiFi is best at a range of less than about 50 feet. Accordingly, in some residences, it may be necessary to extend the range of the WiFi using a WiFi extension device or devices due to a large size of the residence, difficulty in transmitting the WiFi to different rooms, etc.

Conventional in-home WiFi network extension devices include extenders, repeaters, boosters, adapters, wireless transmission devices and routers to extend the network either by means of WiFi, Ethernet over coaxial cable, category cable or powerline. All of these devices require active or powered devices at each end-point and many require circuitry capable of modulation between MoCA or other high band signals and WiFi signals. Although each of these solutions has its unique advantages, all of these solutions are much more complicated and expensive than necessary.

It would be advantageous if a passive cable to WiFi adapter could be developed for the task of coupling WiFi or other wireless signals between coaxial cable and free space while extending the range of a WiFi network.

It may be desirable to provide a wireless adapter configured to extend a wireless range of a wireless network or system.

### SUMMARY

A wireless adapter and/or adapter system is configured to provide enhanced wireless performance, such as an extended wireless range, and may include a receiver that may be configured to receive wireless signals over a first wired connection. The receiver also may be configured to direct the wireless signal to a first wireless device and to direct the wireless signals over a second wired connection to a second wireless adapter so that the second wireless adapter is configured to wirelessly transmit the wireless signals to a second wireless device to extend the wireless range. The second wireless device is outside of a wireless range of the first wireless adapter and the second wireless device is within a wireless range of the first wireless adapter.

In some embodiments, a system for providing enhanced wireless performance may include a first wireless adapter that may be configured to receive wireless signals from a modem or a router, and a second wireless adapter that may be configured to connect to the first wireless adapter. the first wireless adapter may include a first wireless antenna, and the second wireless adapter may include a second wireless antenna. The first wireless adapter may be configured to direct the wireless signals to the first wireless antenna and to direct the wireless signals to the second wireless adapter over a wired connection, and the second wireless adapter may be configured to direct the wireless signals to the second wireless antenna. The second wireless antenna may be configured to wirelessly transmit the wireless signals to a wireless device that is outside a wireless range of the first wireless adapter and is within a wireless range of the second wireless adapter, such that the first wireless adapter and the second wireless adapter are configured to extend a wireless range of the system.

In various embodiments, a system for providing enhanced wireless performance may include a first wireless adapter that may be configured to receive wireless signals, high band signals, and/or cable TV signals from a modem or a router, and a second wireless adapter that may be configured to connect to the first wireless adapter. The first wireless adapter may include a first wireless antenna and a first splitter device, and the second wireless adapter may include a second wireless antenna and a second splitter device. The first splitter device of the first wireless adapter may be configured to direct the wireless signals to the first wireless antenna and to direct the wireless signals, the high band signals, and/or the CATV signals to the second wireless adapter, and the second splitter device of the second wireless adapter may be configured to direct the wireless signals to the second wireless antenna and to direct the wireless signals, the high band signals, and the CATV signals to a high band device, to a CATV device, and/or to a third wireless adapter. The first wireless adapter and the second wireless adapter may be configured to extend a wireless range of the system.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a wireless over cable system in accordance with aspects of the present disclosure.

FIG. 2 illustrates a schematic view of a wireless over cable system in accordance with aspects of the present disclosure.

FIG. 3 illustrates a schematic view of a plurality of wireless over cable systems in accordance with aspects of the present disclosure.

FIG. 4 illustrates a plurality of wireless over cable systems in accordance with aspects of the present disclosure.

FIG. 5 illustrates a plurality of wireless over cable systems in accordance with aspects of the present disclosure.

### DETAILED DESCRIPTION

The present disclosure relates to a WiFi over coaxial “WOC” adapter and a system having a plurality of WOC adapters. In some embodiments, one or more of the WiFi over coaxial adapter devices with a low loss broadband through path may be located at distant end points of a coaxial cable network. The WOC Adapters may be configured to improve whole home Wi-Fi efficiency by coupling the WiFi signals between the coaxial cable and free space and extend a wireless range of the WiFi signals. The coaxial backbone provides a low loss reliable transport medium which bypasses typical Wi-Fi obstructions such as walls. While various embodiments discuss WiFi devices and signals, the embodiments equally apply to any wireless systems and signals.

In some embodiments, the “WoC” adapter may include a WiFi band antenna and an asymmetrical coupler with a 75 ohm F-type cable through put connection. In some embodiments, the impedance match between the WiFi band antenna and the 75 ohm circuit may be achieved via an individual transformer, or an asymmetrical diplex filter or coupled line coupler, although other methods of achieving the impedance match could be used. In some embodiments, the WOC adapter may include an amplifier to boost gain. In some embodiments, the WiFi band antenna may be a 50 Ohm antenna. In some embodiments, the WOC adapter may include a directional coupler and/or a diplexer.

Embodiments disclosed herein provide WOC adapters configured to provide an enhanced wireless performance, such as an increased WiFi or wireless range. In some embodiments, the WOC adapters may be either passive or active. In some embodiments, the WOC adapters may include a WiFi antenna, that may be a patch, SMD, dipole or directional antenna. In some embodiments, the WOC adapters may be integrated partially or wholly into a wall plate. In some embodiments, the WOC adapter or adapters may be wall mounted WOC adapter(s).

In some embodiments, the WOC adapters may be a push on module configured to have an input configured to push onto an output connector of a device such as a modem or router or other output connector. For example, the output connector may be a coaxial output connector.

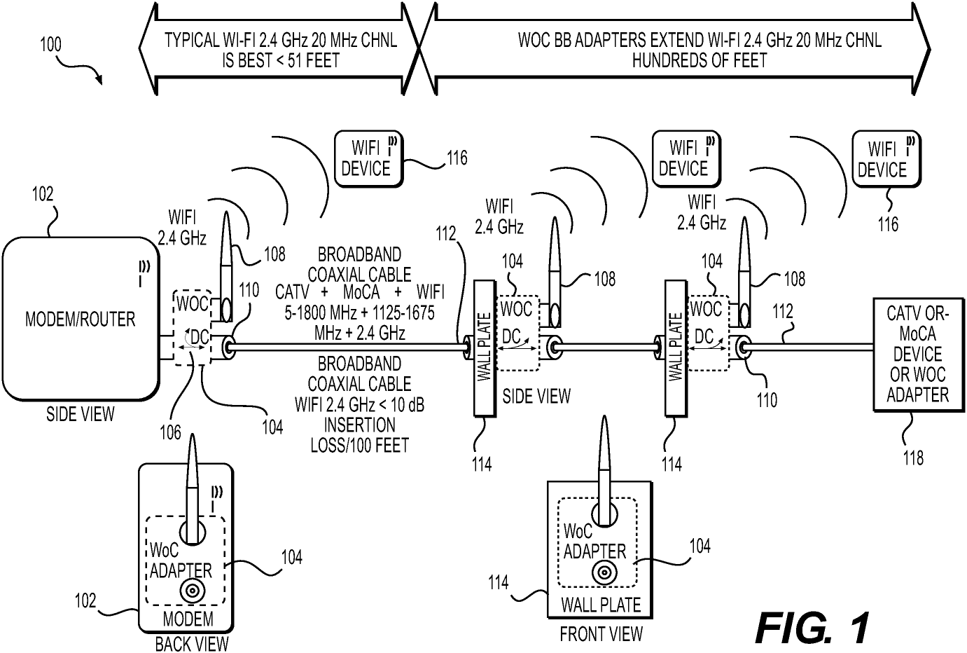

FIG. 1 illustrates a schematic view of a system 100 according to an embodiment. The system 100 is configured to connect to a modem or router 102 and may include a plurality of wireless over cable (WOC) adapters 104. In some embodiments, a first one of the WOC adapters 104 may be connected to a coaxial output port of the modem or router 102. The WOC adapters 104 may each include a WiFi antenna 108 configured to transmit WiFi signals to one or more WiFi devices 116 at a WiFi frequency, such as 2.4 GHz, although other frequencies may be used. The WOC adapters 104 may each include a coaxial output 110 configured to connect to a coaxial cable 112. The WOC adapters 104 may also include a coaxial or other wired input configured to receive input signals. In some embodiments, the coaxial input may be connected to the modem or router 102.

In some embodiments, the WOC adapters 104 may receive at the input CATV signals, MoCA or other high band signals and WiFi or other wireless signals. The CATV signals may be in the frequency band of 5-1800 MHz, the MoCA or other high band signals may be in the frequency band of 1125-1675 MHz, and the WiFi signals may be in the frequency band centered at 2.4 GHz, for example.

In some embodiments, the WOC adapters 104 may also include a directional coupler 106. The directional coupler 106 may be configured to direct the WiFi signals to the WiFi antenna 108, and to direct the WiFi signals, the MoCA or other high band signals and the CATV signals to the coaxial output 110. While a coaxial output 110 is illustrated, other wired output may be used. The WiFi signals that are directed to the WiFi antenna 108 may be broadcast by the WiFi antenna 108 using the WiFi frequency band. The WiFi signals broadcast by the WiFi antenna may be received by WiFi devices 116 that are in a wireless range of the WiFi antenna 108.

A coaxial cable 112 may be used to connect the coaxial output 110 of the WOC adapter to a coaxial input of one or more wall plate 114. A second WOC adapter 104 may be connected to the wall plate 114 and be configured to receive the WiFi signals, the MoCA signals and the CATV signals via the coaxial cable. The second WOC adapter 104 utilizes the directional coupler 106 to direct the WiFi signals to its WiFi antenna 108, and to direct the WiFi signals, the MoCA signals and the CATV signals to either the coaxial input or the coaxial output 110. The WiFi signals that are directed to the WiFi antenna 108 of the second WOC adapter 104 may be broadcast by the WiFi antenna 108 of the second WOC adapter 104. The WiFi signals broadcast by the WiFi antenna 108 may be received by WiFi devices 116 that are in a wireless range of the WiFi antenna 108.

FIG. 1 further illustrates a third WOC adapter 104 connected in the same manner as the second WOC adapter 104. The third WOC adapter 104 functions in the same manner as described for the second WOC adapter 104. Any number of WOC 104 adapters may be connected together in this manner to provide an extended wireless range for the WiFi signals to reach WiFi devices 116 that may otherwise be out of a wireless range of the WiFi antenna.

For example, any WiFi devices that are not within the WiFi wireless range of the first WOC adapter 104 are not able to receive any WiFi signals broadcast by the first WOC adapter 104. For example, in a residence, sometimes a WiFi antenna will not have a wireless range sufficient to reach some WiFi devices in the residence due to a distance being too great between the WiFi antenna and the WiFi device, or when interference prevents the WiFi signal from reaching the WiFi device.

Additionally, in some embodiments, a coaxial cable 112 may be connected between the coaxial output 110 of the first WOC adapter 104 and a CATV or MoCA device 118. Any of the coaxial outputs of the WOC adapters 104 may be connected to an additional WOC adapter 104 and/or to a CATV or MoCA device 118. In some embodiments, the WOC adapters may have more than one coaxial (or other wired) output for connecting to additional WOC adapters and/or to a CATV or MoCA device 118. Each of the WOC adapters may be configured to broadcast WiFi signals to one or more WiFi devices.

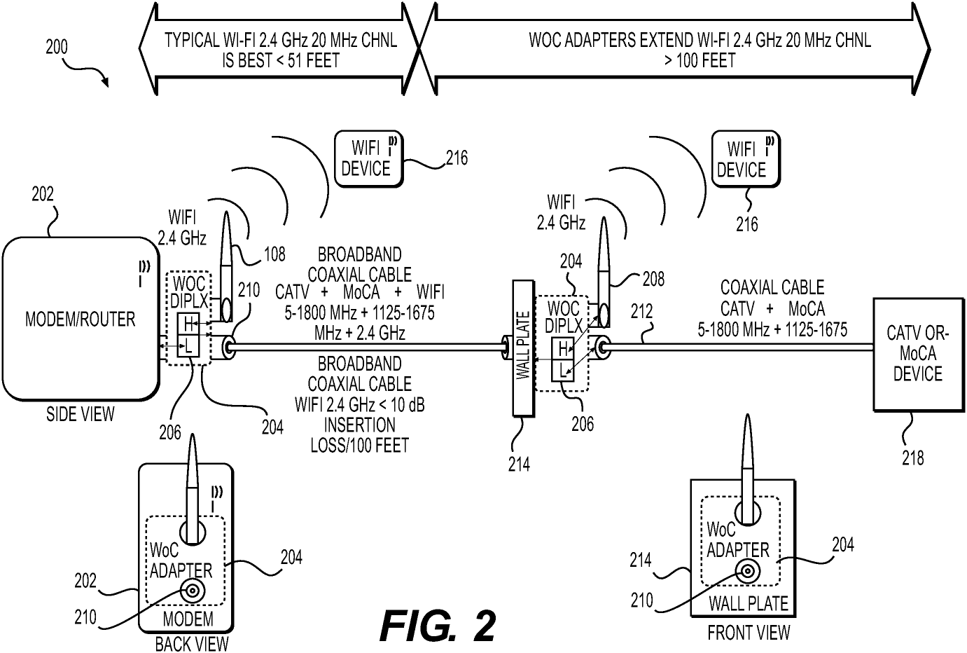

FIG. 2 illustrates a system 200 according to some embodiments. The system 200 includes a modem or router 202 and a plurality of WOC adapters 204. A first WOC adapter 204 may be connected to an output of the modem or router 202. The WOC adapters 204 may each include a WiFi or other wireless antenna 208 configured to transmit WiFi signals to one or more WiFi devices 216 at a WiFi or other wireless frequency, such as 2.4 GHz. The WOC adapters 204 may each include a coaxial output 210 or another wired output configured to connect to a coaxial or other cable 212. The WOC adapters 204 may also include a coaxial or other wired input configured to receive input signals. The coaxial input may be connected to the modem or router 202.

In some embodiments, the WOC adapter 204 may include a diplexer 206. The diplexer 206 is configured to send WiFi signals to the WiFi antenna 208, and to direct the WiFi signals, MoCA or other high band signals and the CATV signals to the coaxial or other wired output 210. The WiFi signals that are directed to the WiFi antenna 208 may be broadcast wirelessly by the WiFi antenna 208. The WiFi signals broadcast by the WiFi antenna 208 may be received by WiFi devices 216 that are in a wireless range of the WiFi antenna 208.

A coaxial or other wired cable 212 may be used to connect the coaxial output 210 of the WOC adapter 204 to a coaxial input of wall plate 214. A second WOC adapter 204 may be connected to or mounted on the wall plate 214 and the second WOC adapter 204 may be configured to receive the WiFi signals, the MoCA signals and the CATV signals over the coaxial cable. The second WOC adapter 204 may be configured to utilize the diplexer 206 to direct the WiFi signals to its WiFi antenna 208, and to direct the WiFi signals, the MoCA signals and the CATV signals to the coaxial output 210. The WiFi signals that are directed to the WiFi antenna 208 of the second WOC adapter 204 may be broadcast wirelessly by the WiFi antenna 208. The WiFi signals broadcast by the WiFi antenna 208 may be received by WiFi devices 216 that are in a wireless range of the WiFi antenna 208. Any number of WOC adapters 204 may be connected together in this manner to provide an extended wireless range for the WiFi signals to reach WiFi devices 116. For example, WiFi devices 216 that are outside the wireless range of the first WOC adapter 204 may still receive the WiFi signals from another (second or subsequent WOC adapter 204.

Additionally, in some embodiments, the coaxial cable 212 may be connected between the coaxial output 210 of the WOC adapter 204 and a CATV or MoCA device 218. Any of the coaxial outputs of the WOC adapters 204 may be connected to an additional WOC adapter 204 and/or to a CATV or MoCA device 218.Any of the WOC adapters 204 may have more than one coaxial output 210.

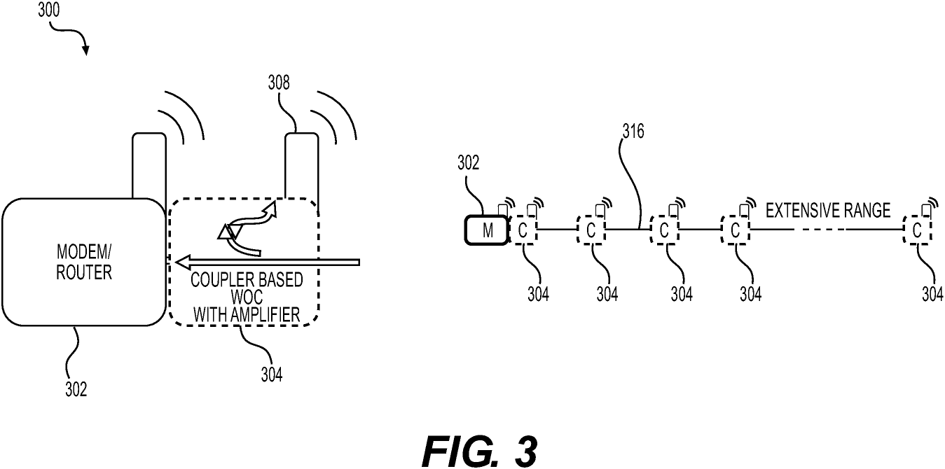

FIG. 3 illustrates a system 300 according to some embodiments. The system 300 includes a modem or router 302 and one or more WOC adapters 304. The WOC adapter 304 may include a directional coupler as explained in conjunction with FIG. 1 to direct WiFi or other wireless signals to WiFi or wireless antenna 308, and to direct CATV, MoCA and WiFi signals to a coaxial output. Any number of WOC adapters 304 may be connected together in a series manner to provide extended wireless range for reaching WiFi devices in a same manner as previously described. Additionally, one or more of the WOC adapters 304 may include an amplifier as shown in the first WOC adapter 304 of FIG. 3.

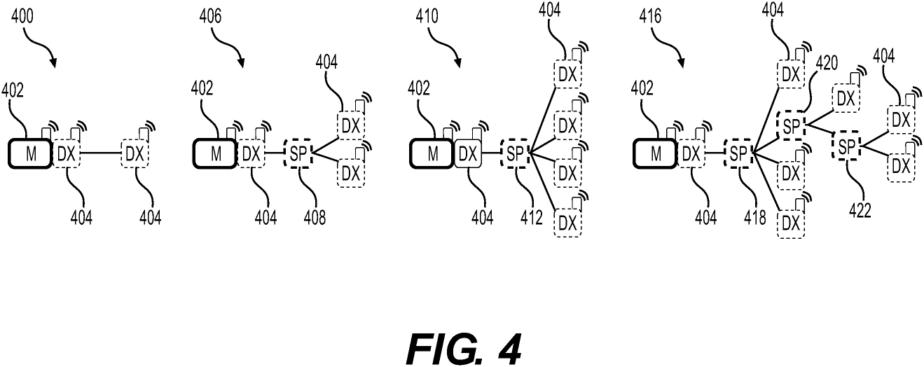

FIG. 4 illustrates systems 400, 406, 410 and 416 according to some embodiments. The systems 400, 406, 410 and 416 illustrate various configurations that the WOC or wireless adapters 404 may be arranged in. In system 400, a modem or router 402 is connected to first and second WOC adapters 404 in a serial manner. In some embodiments, the WOC adapters 404 may include a diplexer and a wireless antenna. Additionally, one or more of the WOC adapters 404 may include an amplifier.

In system 406, a modem or router 402 is connected to a first WOC adapter 404. The first WOC adapter 404 is connected to a splitter 408 (in this case a 2-way splitter, although other splitters may be used), which directs signals to two additional WOC adapters 404.

In system 410, a modem or router 402 is connected to a first WOC adapter 404. The first WOC adapter 404 is connected to a splitter 412 (in this case a 4-way splitter), which directs signals to four additional WOC adapters 404.

In system 416, a modem or router 402 is connected to a first WOC adapter 404. The first WOC adapter 404 is connected to a first splitter 418, which directs the signals to three additional WOC adapters 404 and a second splitter 420. The second splitter 420 is connected to and directs signals to another WOC adapter 404 and a third splitter 422. The third splitter 422 is connected to and directs signals to two additional WOC adapters 404.

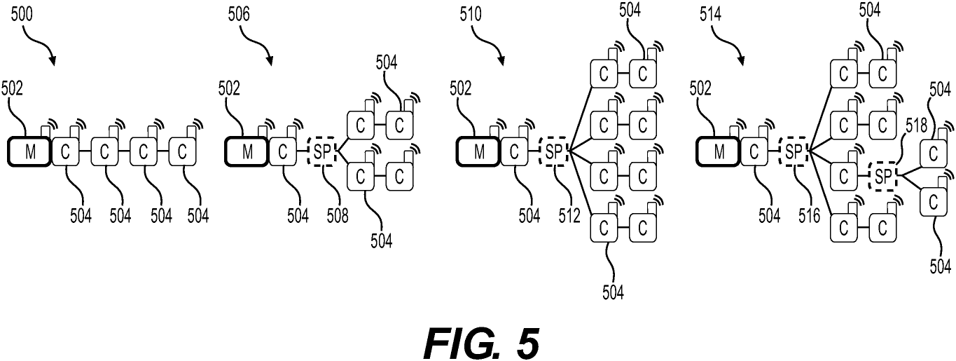

FIG. 5 illustrates systems 500, 506, 510 and 514. The systems 500, 506, 510 and 514 illustrate various configurations that the WOC or wireless adapters 504 may be arranged in. In system 500, a modem or router 502 is connected to first and second WOC adapters 504 in a serial manner. Any number of WOC adapters 504 may be connected together in this manner. The WOC adapters 504 may include a directional coupler and a wireless antenna as previously described. Coupler based WOC adapters have the advantage of a broadband low loss throughput unconstrained by filters and may be cascaded with other WOCs to daisy chain the network. Additionally, one or more of the WOC adapters 504 may include an amplifier.

The system 506 may include a modem or router 502 connect to a first WOC adapter 504. An output of the first WOC adapter 504 is connected to a two-way splitter 508. Outputs of the splitter 508 are connected to third and fourth WOC adapters 504. Fifth and sixth wireless adapters 504 are connected to outputs of the third and fourth WOC adapters 504 in a serial manner.

The system 510 includes a modem or router 502 connect to a first WOC adapter 504. An output of the first WOC adapter 504 is connected to a four-way splitter 512. Outputs of the splitter 512 are connected to third, fourth, fifth and sixth WOC adapters 504. Outputs of the third, fourth, fifth and sixth WOC adapters 504 are connected to seventh, eighth, ninth and tenth WOC adapters 504 in a serial manner.

The system 514 includes a modem or router 502 connect to a first WOC adapter 504. An output of the first WOC adapter 504 is connected to a four-way splitter 516. Outputs of the splitter 516 are connected to third, fourth, fifth and sixth WOC adapters 504. Outputs of three of the third, fourth, fifth and sixth WOC adapters 504 are connected to seventh, eighth and ninth WOC adapters 504 in a serial manner. An output of the fourth of the third, fourth, fifth and sixth WOC adapters 504 is connected to a two-way splitter 518. Outputs of the splitter 518 are connected to tenth and eleventh WOC adapters 504.

The configurations of the systems illustrated herein are merely examples and the WOC or wireless adapters that can be configured in many possible configurations with the use of splitters and/or amplifiers to provide enhanced wireless performance, such as an extended WiFi or wireless range as needed.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What is claimed is:

1. A system for providing enhanced wireless performance, comprising:
a first wireless adapter configured to receive wireless signals, high band signals and cable TV signals from a modem or a router;
a second wireless adapter configured to connect to the first wireless adapter;
wherein the first wireless adapter includes a first wireless antenna and a first splitter device;
wherein the second wireless adapter includes a second wireless antenna and a second splitter device;
wherein the first splitter device of the first wireless adapter is configured to direct the wireless signals to the first wireless antenna and to direct the wireless signals, the high band signals, and the CATV signals to the second wireless adapter;
wherein the second splitter device of the second wireless adapter is configured to direct the wireless signals to the second wireless antenna and to direct the wireless signals, the high band signals, and the CATV signals to a high band device, to a CATV device, and/or to a third wireless adapter; and
wherein first wireless adapter and the second wireless adapter are configured to extend a wireless range of the system.

2. The system of claim 1, wherein the first wireless adapter is configured to connect to the second wireless adapter by a wired connection.

3. The system of claim 1, wherein the wireless signals are WiFi signals and the high band signals are MoCA signals.

4. The system of claim 1, wherein the first and second wireless adapters are WOC (“wireless-over-cable”) adapters configured to transmit WiFi signals between the first and second wireless adapters over a coaxial connection and configured to wirelessly transmit WiFi signals to wireless devices.

5. The system of claim 1, wherein the first wireless adapter is configured to direct the wireless signals to the second wireless adapter, and the second wireless adapter is configured to wirelessly transmit the wireless signals received from the first wireless adapter to a wireless device, and wherein the wireless device is not within a wireless range of the first wireless device but is within a wireless range of the second wireless device such that a wireless range of the system is extended.

6. The system of claim 1, wherein the splitter device comprises one of a directional coupler or a diplexer.

7. The system of claim 1, wherein the first wireless adapter further comprises an amplifier configured to amplify the wireless signals.

8. A system for providing enhanced wireless performance, comprising:
a first wireless adapter configured to receive wireless signals from a modem or a router;
a second wireless adapter configured to connect to the first wireless adapter;
wherein the first wireless adapter includes a first wireless antenna;
wherein the second wireless adapter includes a second wireless antenna;
wherein the first wireless adapter is configured to direct the wireless signals to the first wireless antenna and to direct the wireless signals to the second wireless adapter over a wired connection;
wherein the second wireless adapter is configured to direct the wireless signals to the second wireless antenna;
wherein the second wireless antenna is configured to wirelessly transmit the wireless signals to a wireless device; and
wherein the wireless device is outside a wireless range of the first wireless adapter and is within a range of the second wireless adapter, such that the first wireless adapter and the second wireless adapter are configured to extend a wireless range of the system.

9. The system of claim 8, wherein the first wireless adapter is configured to receive the wireless signals, high band signals and CATV signals from a modem or a router.

10. The system of claim 9, wherein the wireless signals are WiFi signals and the high band signals are MoCA signals.

11. The system of claim 8, wherein the first wireless adapter is configured to send the wireless signals, the high band signals and the CATV signals to the second wireless adapter over the wired connection.

12. The system of claim 8, wherein the first wireless adapter and the second wireless adapter comprise one of a directional coupler or a diplexer.

13. The system of claim 8, wherein the first wireless adapter further comprises an amplifier configured to amplify the wireless signals.

14. A wireless adapter configured to provide an enhanced wireless performance, comprising:
a receiver configured to receive wireless signals over a first wired connection;
wherein the receiver is further configured to direct the wireless signal to a first wireless device and to direct the wireless signals over a second wired connection to a second wireless adapter so that the second wireless adapter is configured to wirelessly transmit the wireless signals to a second wireless device to extend the wireless range; and
wherein the second wireless device is outside of a wireless range of the first wireless adapter and the second wireless device is within a wireless range of the first wireless adapter.

15. The wireless adapter of claim 14, further comprising a wireless antenna configured to wirelessly transmit the wireless signals to the first wireless device.

16. The wireless adapter of claim 15, wherein the receiver comprises a splitter, wherein the splitter is configured to receive the wireless signals, CATV signals and high band signals from a modem or a router.

17. The wireless adapter of claim 16, wherein the splitter is configured to direct the wireless signals to the wireless antenna and to direct the wireless signals, the high band signals and the CATV signals to the second wireless adapter.

18. The wireless adapter of claim 16, wherein the wireless signals are WiFi signals and the high band signals are MoCA signals.

19. The wireless adapter of claim 16, wherein the splitter comprises one of a directional coupler or a diplexer.

20. The wireless adapter of claim 14, further comprising an amplifier configured to amplify the wireless signals.
